(19) United States
(12) Patent Application Publication
(10) Pub. No.: US 2007/0206791 A1
(43) Pub. Date: Sep. 6, 2007

(54) Image processing apparatus

(75) Inventors: Yuji Okamoto, Kyoto (JP); Naofumi Ueda, Kyoto (JP); Tsutomu Yoshimoto, Nara (JP); Syoichiro Yoshiura, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/699,158

(22) Filed: Jan. 26, 2007

(30) Foreign Application Priority Data
Feb. 20, 2006 (JP) JP2006-042483

(51) Int. Cl. G09C 5/00

(52) U.S. Cl. 380/54

(57) ABSTRACT

The security of image data is enhanced by utilizing operation keys used in performing image processing and by generating an apparatus-specific encryption key to encrypt the image data with the encryption key. Generation of the encryption key is started when an input is made with a specific operation key. Every input made by operating an operation key on an operation panel is converted into a key code corresponding to that operation key. After sequential repetitions of this process, the key input is finished when an input is made with the specific operation key. The key codes are arranged in the order of operation to generate a key code string, the arrangement of which is then converted. The encryption key is generated based on the key code string.

### BACKGROUND OF THE INVENTION

1. Field of the Invention

The present invention relates to an image processing apparatus that encrypts image data and performs certain processing on the image data.

2. Description of the Related Art

For preventing leakage of image data, image processing apparatuses may encrypt the image data before storing it in a storage device or transmitting it. A specific encryption key is used for the encryption. This encryption key is automatically generated by a computer, for example, as described in Japanese Patent Laid-Open No. 2003-169047. Alternatively, the encryption key is generated based on time information on the time when the image data is input, as described in Japanese Patent Laid-Open No. 2005-311950.

The encryption key generated in the above manner is a random combination of numbers and alphabets. The encryption key may be found out by a computer as long as a controller, which is a computer provided in the image processing apparatus, automatically generates the encryption key.

An image processing apparatus has various functions such as copy, scanner, and facsimile functions. Many operation keys are provided for operations for each function. Therefore, the operation keys are unique to the apparatus. Utilizing these operation keys for generation of the encryption key will be able to provide a highly secure encryption key.

In the light of the above, an object of the present invention is to provide an image processing apparatus capable of utilizing the characteristic of performing a variety of image processing to generate an encryption key unique to the apparatus and to encrypt image data with the encryption key, thereby enhancing the security of the image data.

### SUMMARY OF THE INVENTION

The present invention is an image processing apparatus that encrypts image data with an encryption key, including generation means for generating the encryption key based on details of an input operation.

That is, a user may perform various operations on the apparatus. In an image processing apparatus capable of multi-function image processing, the details of operations are also wide-ranging. Utilizing this fact to generate the encryption key according to the details of the input operation can provide the encryption key unique to the apparatus. Thus, the encryption key hard to be estimated is generated. Encrypting image data with this encryption key makes the image data hard to be decrypted, thereby allowing prevention of information leakage.

The image processing apparatus includes input means for generating a signal when operated. The generation means includes means for converting the signal input by the input means into a key code, and means for generating the encryption key from the key code.

The input means may include operation keys for performing image processing. The operation keys cause desired image processing to be performed and are operated to output signals. The details of operation vary for each operation key, so that a corresponding key code is set for a signal from each operation key. Therefore, different encryption keys can be generated based on the details of different operations.

The input means may include a detecting device for detecting a mechanical change in the apparatus and outputting a signal. The detecting device is a switch or a sensor, which outputs a sensing signal when it senses a mechanical change in the image processing apparatus, such as the opening or closing of a door or cover or the attachment or detachment of removable parts. To cause such a mechanical change is an operation on the apparatus. Therefore, performing an operation that causes a mechanical change allows the detecting device for that operation to output a signal. A corresponding key code is also set for each signal from the detecting device. Thus, an encryption key hard to be estimated in a typical manner can be generated.

The image processing apparatus varies in its functions depending on the type of the apparatus. That is, the operation keys are apparatus-specific unique keys. An operation key existing on one type of apparatus may not exist on other types of apparatuses. Generating the encryption key with such operation keys to encrypt image data makes the image data incapable of being decrypted in other types of apparatuses, thereby enhancing the security.

Furthermore, different encryption keys are generated for different kinds of image processing. The image processing includes processing such as transmission of the image data and storage of the image data. For different kinds of image processing, different encryption keys are generated to encrypt the image data. Therefore, registration means for registering the encryption keys is provided, so that one of the encryption keys is selected depending on the image processing. The encryption keys are generated and registered in advance. By varying the encryption key in this manner, even if one encryption key is found out, image data encrypted with other encryption keys can be protected.

According to the present invention, since the encryption key is generated based on an operation specific to the image processing apparatus, the encryption key that cannot be known by other persons can be provided. Therefore, the encryption key cannot be easily estimated even if it is leaked out. Encrypting image data with such a strong encryption key makes the image data hard to be decrypted. This enhances the security of the image data, thereby implementing a highly secure image processing apparatus.

### BRIEF DESCRIPTION OF THE DRAWINGS

FIG. 1 is a diagram showing a general configuration of an image processing apparatus of the present invention;

FIG. 2 is a diagram showing an operation panel;

FIG. 3 is a diagram showing screens of operation menus for different operations;

FIG. 4 is a diagram showing screens of operation menus for different operations;

FIG. 5 is a flowchart of encryption processing;

FIG. 6 is a diagram showing screens at the start of the encryption processing;

FIG. 7 is a diagram showing screens at the start of generation of an encryption key;

FIG. 8 is a diagram showing an example of input with operation keys for generating the encryption key;

FIG. 9 is a flowchart of generating the encryption key;

FIG. 10 is a diagram showing a table indicating the correspondence between operation keys and key codes; and

FIG. 11 is a diagram showing operation panels for different apparatus types.

### DETAILED DESCRIPTION OF THE PREFERRED EMBODIMENTS

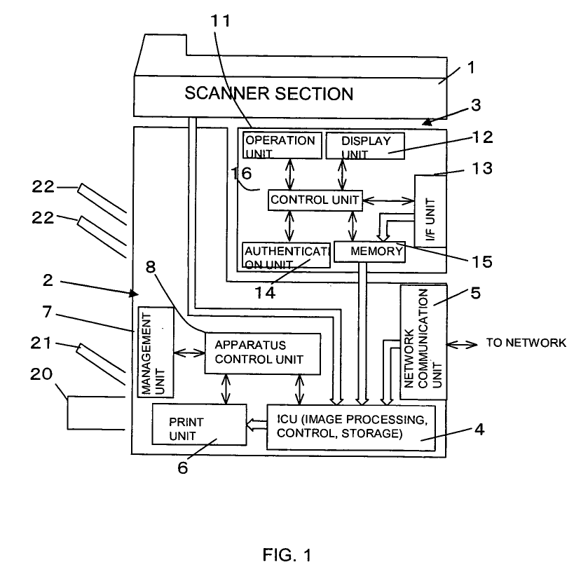

FIG. 1 shows an image processing apparatus in an embodiment. The image processing apparatus is a digital multifunction machine executing a copy mode, a print mode, a scanner mode, and a facsimile mode and includes: a scanner section 1 that scans a document and inputs image data; an image data processing section 2 that processes the image data; and an information processing section 3 that processes input information such as authentication information.

The image data processing section 2 includes: an image processing unit 4 that edits, stores, and outputs the input image data; a network communication unit 5 that transmits and receives data to and from external apparatuses over a network; a print unit 6 that prints out the image data; a management unit 7 that stores information such as control information on the entire apparatus and setting information; and an apparatus control unit 8 that consists of a CPU responsible for controlling the entire apparatus. The image processing unit 4 includes a hard disk device and memory for storing the image data.

The information processing section 3 includes: an operation panel including an operation unit 11 for input operations and a display unit 12 such as a liquid crystal display; an interface unit 13 that communicates with mobile terminals such as USB devices and IC cards; an authentication unit 14 that authenticates the authentication information input from the operation unit 11 or the interface unit 13; a memory 15 that stores input information such as operation information and the authentication information; and a control unit 16 that processes the operation information and the authentication information. The display unit 12 is of a touch-panel type and functions as part of the operation unit. Communication by the interface unit 13 may be either wired or wireless.

The image processing apparatus is connected to a network such as a LAN or a WAN. Also connected to this network are information processing apparatuses implemented as personal computers, and other image processing apparatuses. The network is further connected to the Internet from a router through a communication line such as a telephone line or a fiber-optic line. The image processing apparatus can communicate using a certain communication protocol with external apparatuses, such as information processing apparatuses within the network and information processing apparatuses connected to the Internet. Communication between image processing apparatuses is also possible. The image processing apparatus has a modem device (not shown) so that data can be communicated with a facsimile machine via the telephone line.

Image data is transmitted from an external apparatus to the image processing apparatus over the network. The network communication unit 5 in the image processing apparatus receives and inputs the image data. In the case of facsimile communication, the modem device inputs the image data. Image data is also input from the scanner section 1. That is, the network communication unit 5, the modem device, and the scanner section 1 function as data input means.

In response to the input of the image data, the apparatus control unit 8 performs processing in the print mode, copy mode, scanner mode, or facsimile mode based on information, such as input information from the operation unit 11 and processing setting information contained in header information of the input image data.

In the print mode and copy mode, the image processing unit 4 performs image processing on the image data, and then the print unit 6 prints out image on a sheet material. That is, the image processing unit 4 and the print unit 6 function as image recording means for recording image on a sheet material.

A feed unit that feeds sheet materials to the print unit 6 and ejection unit that ejects the sheet materials from the print unit 6 are provided. The feed unit has cassette trays 20 and manual feed trays 21 as holders for holding the sheet materials. Under instructions of the apparatus control unit 8, the feed unit takes the sheet materials one by one out of a selected holder and conveys them to the print unit 6. The ejection unit has ejection trays 22. Under instructions of the apparatus control unit 8, the ejection unit ejects the sheet materials conveyed from the print unit 6 to their specified ejection trays 22 respectively.

In the scanner mode, the image data is stored in the hard disk device and then transmitted to an external apparatus in response to a request from the external apparatus. In the facsimile mode, the image data is transmitted to a facsimile machine.

The apparatus control unit 8 uses an encryption key to encrypt the image data subjected to the image processing. This encryption processing is done by computation with a known algorithm such as AES (Advanced Encryption Standard). The encrypted image data is stored in the hard disk device or the memory. Then, in the copy mode and the print mode, the apparatus control unit 8 decrypts the stored image data and print out image on a sheet material. In the facsimile mode and the scanner mode, the apparatus control unit 8 transmits the encrypted image data to a specified destination. Thereafter, on completion of the specific processing, the image data is erased. Encrypting the image data in this manner can prevent information leakage since the image data cannot be decrypted even if an unauthorized access is made to the image processing apparatus to steal the stored image data. Likewise, even if the image data is intercepted during transmission, information leakage can be prevented since again the image data cannot be decrypted.

The apparatus control unit 8 includes generation means for generating an encryption key. The generation means generates an encryption key based on the details of input operation. That is, when a user operates the operation unit 11, an encryption key is generated according to the details of the operation.

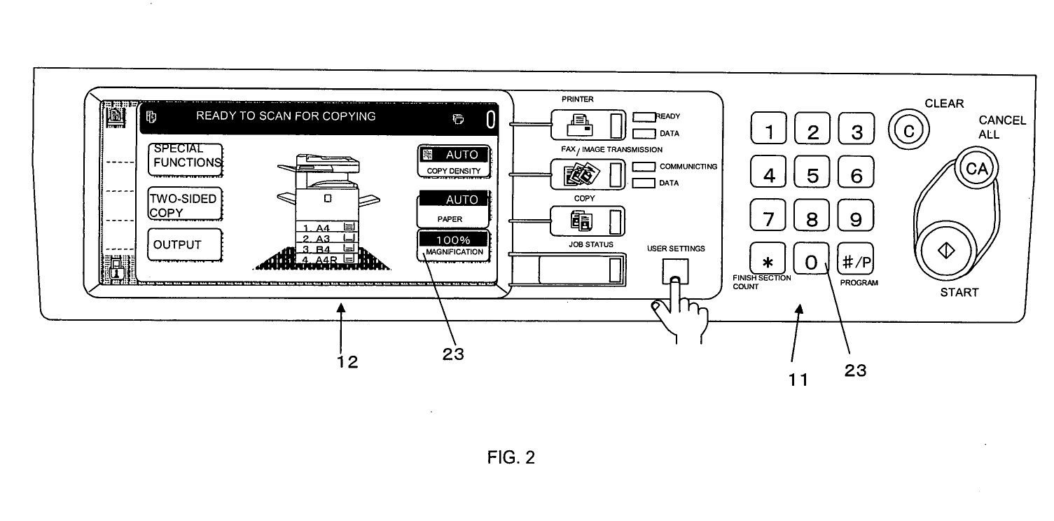

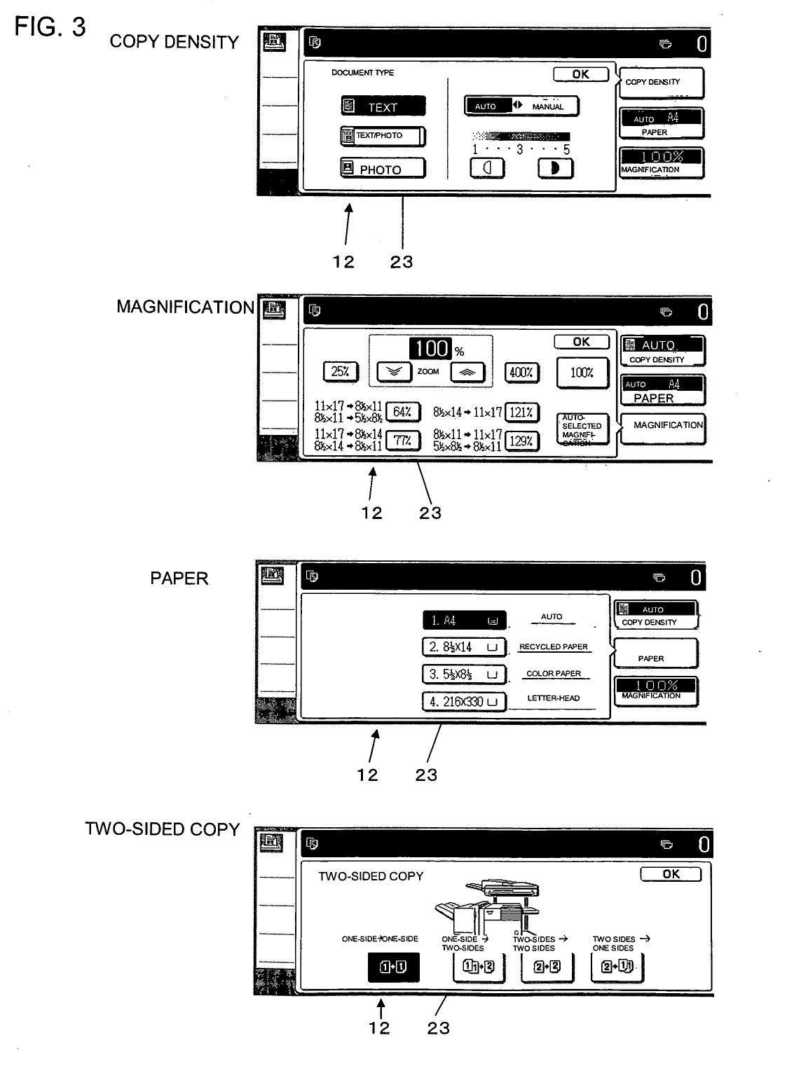

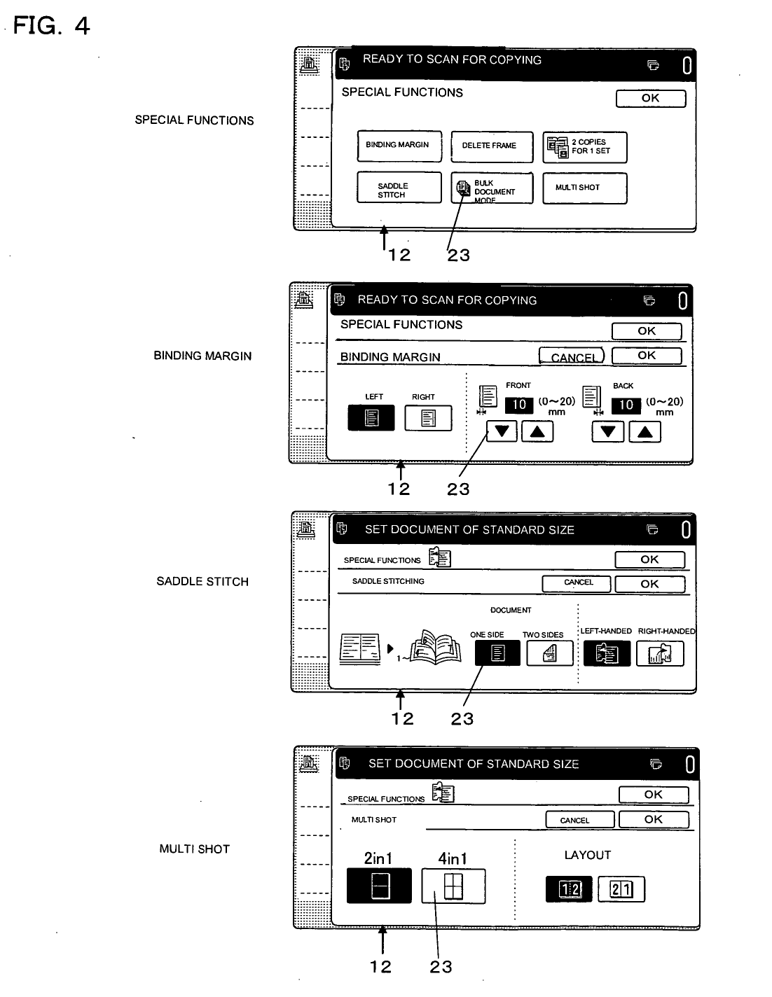

As shown in FIG. 2, the operation panel includes the operation unit 11 and the touch-panel display unit 12, where a number of operation keys 23 exist in the operation unit 11. Also as shown in FIGS. 3 and 4, operation keys 23 on the screen are provided for operation menus displayed on the display unit 12. Since the operation menus are hierarchically structured, different sets of operation keys 23 exist for different operation menus. These operation keys 23 are unique keys each corresponding to a unique operation, so that operating each operation key 23 causes a unique signal to be generated. When the user operates an operation key 23, the apparatus control unit 8 receives an output signal from the operation key 23 and recognizes which operation key 23 has been operated.

Therefore, for generating an encryption key based on the user's operation of the operation keys 23, the apparatus control unit 8 includes means for converting output signals from the operated operation keys 23 into corresponding key codes, and means for generating an encryption key from the key codes.

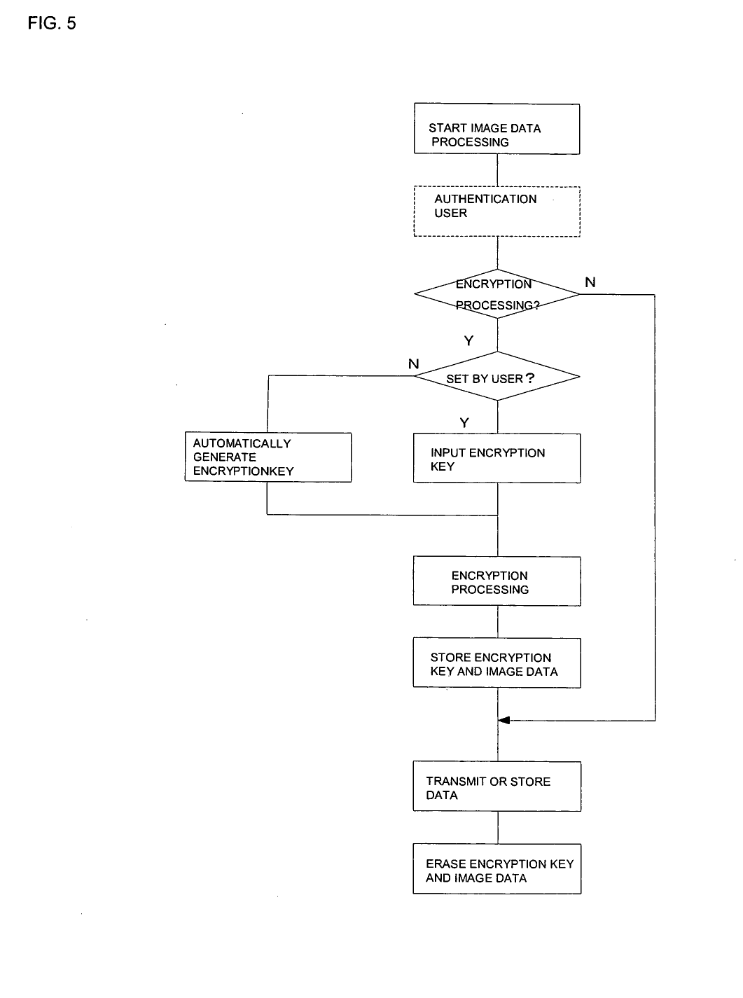

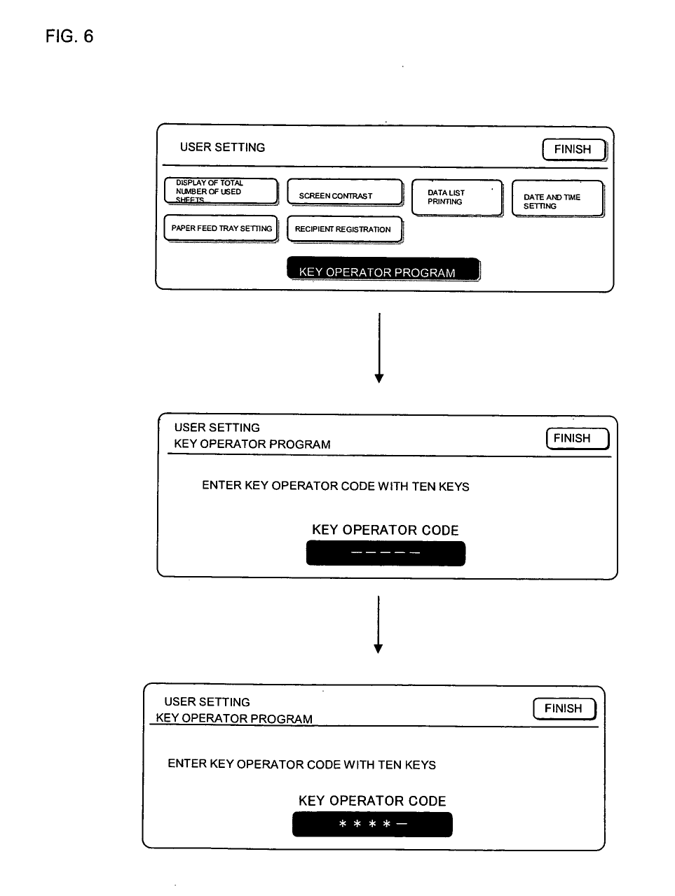

A process in processing the image data with encryption will be described based on FIG. 5. When the image data is input from the network communication unit 5, the modem device, or the scanner section 1, processing in a specified mode is started. The apparatus control unit 8 first authenticates the user. As shown in FIG. 6, a screen for inputting authentication information such as a password is displayed on the display unit 12. The authentication unit 14 authenticates the input authentication information. This authentication may not be performed in some cases.

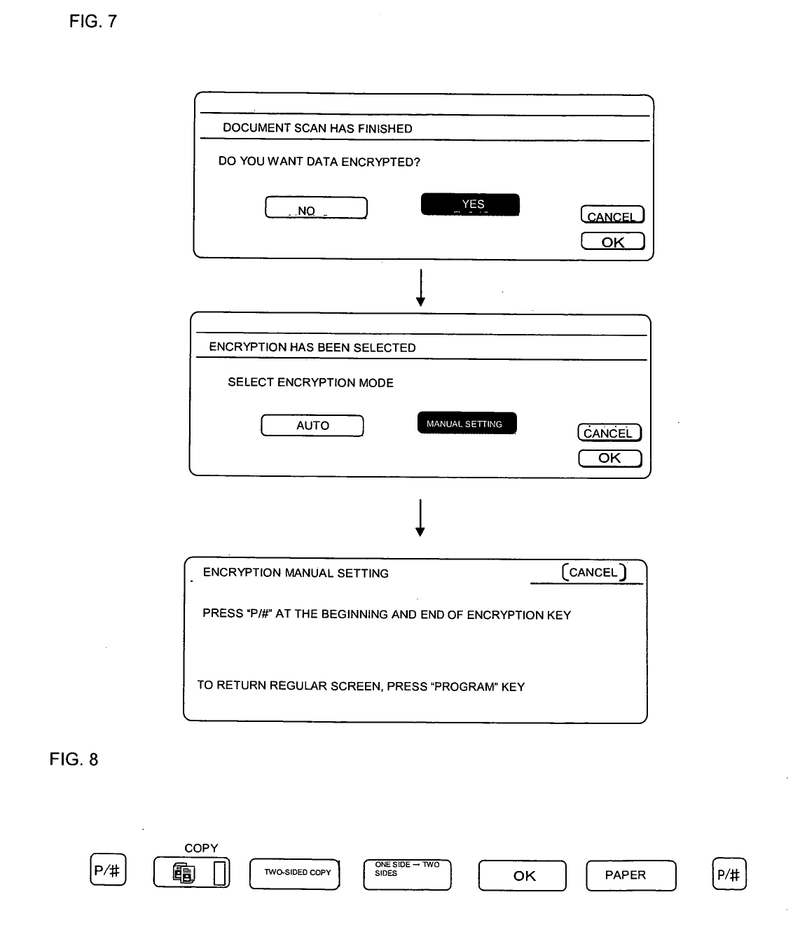

When the user specifies that encryption be performed, a screen for selecting between automatic generation and manual generation of an encryption key is displayed as shown in FIG. 7. If automatic generation is selected, the apparatus control unit 8 automatically generates an encryption key. If manual generation is selected, the apparatus control unit 8 displays a generation screen.

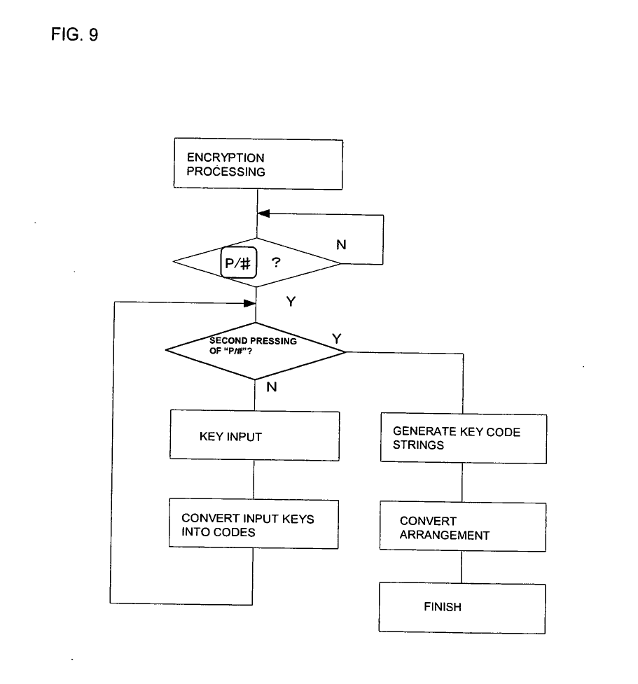

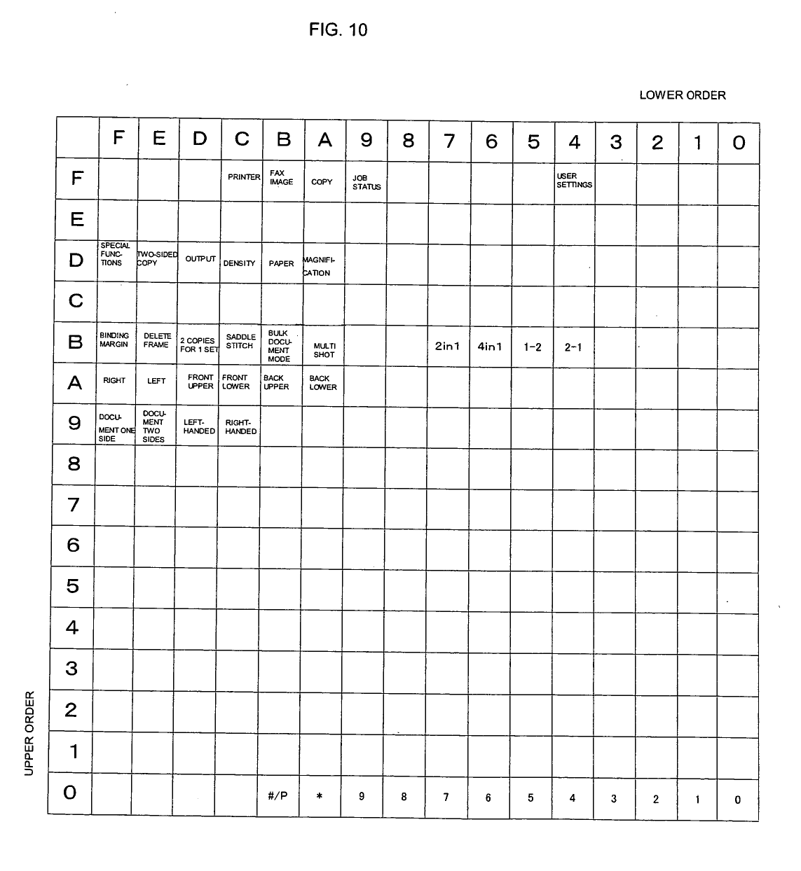

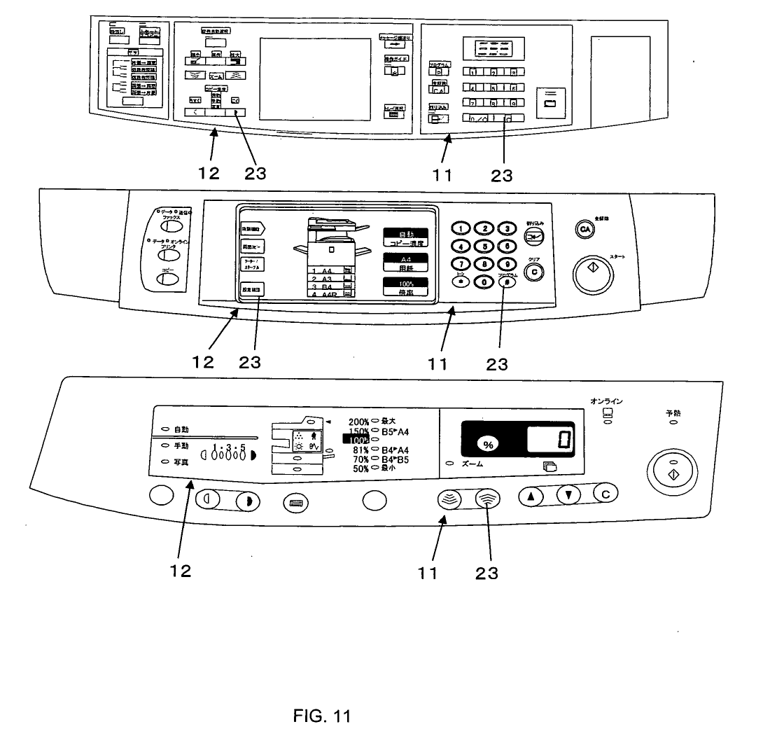

As shown in FIGS. 8 and 9, the user operates a specific operation key 23 for starting an input and then operates desired operation keys 23. The user finally operates the specific operation key 23 to finish the input. The apparatus control unit 8 converts the input into key codes based on output signals from the operation keys 23. A corresponding key code is set for each operation key 23, and, as shown in FIG. 10, a table indicating the correspondence between the key codes and the operation keys 23 is stored in the memory in advance. The codes are converted with reference to this table.

The apparatus control unit 8 generates a key code string by arranging the converted key codes in the order in which the operation keys 23 have been operated. Then, for enhancing the security, the apparatus control unit 8 converts the arrangement according to a predetermined rule and generates an encryption key based on the converted arrangement. In this manner, the encryption key is generated based on the details of the user-input operations. Therefore, since a number of operation keys 23 are utilized to generate the encryption key, the generated encryption key is unique to the apparatus and therefore hard to be estimated. As a result, the encrypted image data is also hard to be decrypted, allowing the enhancement of the security. In addition, since the encryption key can be generated according to the order in which the operation keys 23 frequently used by the user are operated, the encryption key can be easy for the user to remember.

The apparatus control unit 8 uses the encryption key to encrypt the image data that has been input and subjected to image processing, and stores the encryption key and the encrypted image data in the memory. The encrypted image data is thereafter processed, such as transmitted or stored in the hard disk device, depending on the specified mode. On completion of the processing in that mode, the encryption key and the image data is erased.

Having received the encrypted image data, another image processing apparatus or external apparatus decrypts the received image data with a decryption key and performs certain processing. In the case where the encrypted image data is stored in the image processing apparatus, the image processing apparatus reads out the image data and decrypts the encrypted image data with a decryption key to output it such as by printing or data transmission. Here, the encryption processing and decryption processing adopt the common key system, where the same key is used as the encryption key and the decryption key. However, the public key system may be used, where different keys are used as the encryption key and the decryption key, respectively.

The image processing apparatus includes a detecting device for detecting a mechanical change in the apparatus. For example, the detecting device may be a switch for sensing the opening or closing of a door, a switch for sensing the opening or closing of a document cover, a switch for sensing the presence or absence of a document, a switch for sensing the presence or absence of a cassette tray, a sensor for sensing the document size, or a sensor for sensing the sheet material size. When some operation is performed on the image processing apparatus and a change in the state of the door, the cover, or the like is sensed, the switch or sensor outputs a signal to the apparatus control unit 8.

Once the user performs a certain operation for generating an encryption key, such as opening or closing a door, the detecting device generates a signal. The apparatus control unit 8 converts the output signals from the detecting device into key codes and generates the encryption key in the same manner as described above. A combination of the operation of the operation keys 23 and the operation of the apparatus may be used to generate the encryption key. In this manner, the encryption key may also be generated based on the details of operation performed on the apparatus. This allows generation of a more complicated encryption key, thereby enhancing the security.

In the image processing apparatus, the image data is subjected to image processing according to a specified mode. Therefore, the apparatus control unit 8 generates different encryption keys for different kinds of image processing. The image data in different kinds of image processing is encrypted with different encryption keys. Thus, if wrong image data is selected and output, information leakage is prevented since this image data cannot be decrypted.

The apparatus control unit 8 registers the encryption keys generated in advance by storing them in the hard disk device or other locations. According to the image processing, one of the registered encryption keys is selected and used to encrypt the image data. This selection may be made by the user or automatically made by the apparatus control unit 8.

The image processing apparatus varies in its functions depending on the type of the apparatus. FIG. 11 shows the operation panels for three apparatus types. Each operation panel has different kinds of and a different number of operation keys. A higher-level apparatus type has more operation keys 23 than a lower-level apparatus type. That is, the operation keys 23 are apparatus-specific unique keys. An encryption key generated in one type of apparatus is not compatible with an encryption key generated in other types of apparatuses. Therefore, if an encryption key is generated with the operation keys 23 unique to one apparatus, the encryption key is not available for unauthorized use in other types of apparatuses, resulting in the failure of decryption of the encrypted image data. Thus, even if the image data is fraudulently taken out, information leakage can be prevented because the image data cannot be decrypted. However, since a higher-level apparatus includes functions of a lower-level apparatus, the higher-level apparatus can use an encryption key generated in the lower-level apparatus and decrypt the image data.

It is to be understood that the present invention is not limited to the above-described embodiment but many modifications and alterations may be made to the above-described embodiment within the scope of the present invention. The image processing apparatus may be a multifunction machine with a copy mode and a facsimile mode, or even a special-purpose machine only with a single mode, such as a copier or a facsimile machine.

What is claimed is:

1. An image processing apparatus that encrypts image data with an encryption key, comprising generation means for generating the encryption key based on details of an input operation.

2. The image processing apparatus according to claim 1, comprising input means for generating a signal when operated, wherein the generation means comprises:
means for converting the signal input by the input means into a key code; and
means for generating the encryption key from the key code.

3. The image processing apparatus according to claim 1, wherein different encryption keys are generated for different kinds of image processing.

4. The image processing apparatus according to claim 3, comprising registration means for registering a plurality of encryption keys, wherein one of the encryption keys is selected depending on the image processing.

5. The image processing apparatus according to claim 1, wherein the input means comprises operation keys for performing image processing.

6. The image processing apparatus according to claim 2, wherein the input means comprises operation keys for performing image processing.

7. The image processing apparatus according to claim 3, wherein the input means comprises operation keys for performing image processing.

8. The image processing apparatus according to claim 4, wherein the input means comprises operation keys for performing image processing.

9. The image processing apparatus according to claim 1, wherein the input means comprises operation keys for performing image processing and a detecting device for detecting a mechanical change in the apparatus and outputting a signal.

10. The image processing apparatus according to claim 2, wherein the input means comprises operation keys for performing image processing and a detecting device for detecting a mechanical change in the apparatus and outputting a signal.

11. The image processing apparatus according to claim 3, wherein the input means comprises operation keys for performing image processing and a detecting device for detecting a mechanical change in the apparatus and outputting a signal.

12. The image processing apparatus according to claim 4, wherein the input means comprises operation keys for performing image processing and a detecting device for detecting a mechanical change in the apparatus and outputting a signal.

13. The image processing apparatus according to any of claims 5 to 12, wherein the operation keys are apparatus-specific unique keys.
